(19) United States
(12) Patent Application Publication
(10) Pub. No.: US 2023/0234106 A1
(43) Pub. Date: Jul. 27, 2023

(54) COATING REMOVAL SYSTEM AND METHODS OF OPERATING SAME

(71) Applicant: ULTRA CLEAN HOLDINGS, INC., Hayward, CA (US)

(72) Inventors: Kenneth Allen AITCHISON, Calabasas, CA (US); John Gilbert DEEM, Mesa, AZ (US)

(21) Appl. No.: 18/159,614

(22) Filed: Jan. 25, 2023

Related U.S. Application Data
(60) Provisional application No. 63/303,237, filed on Jan. 26, 2022.

(51) Int. Cl. B08B 3/10; B08B 3/04

(52) U.S. Cl. CPC B08B 3/106; B08B 3/045; B08B 2203/007

(57) ABSTRACT

A coating removal process includes providing a coating removal vessel having a sealable processing volume therein, providing a coating removal fluid, which reacts with the coating, at an elevated temperature above the ambient temperature surrounding the removal vessel, in the sealable processing volume, locating a component having a coating thereon to be removed in the processing volume, sealing the sealable process volume from the ambient surrounding the processing volume, heating the coating removal fluid to a temperature greater than the boiling point thereof at the pressure of the surrounding ambient, removing the coating from the component using the coating removal fluid at the temperature greater than the boiling point thereof at the pressure of the surrounding ambient, reducing the temperature of the coating removal fluid to a temperature less than the boiling point thereof at the pressure of the surrounding ambient, venting the sealable volume to the surrounding ambient, and removing the component from the processing volume.

### CROSS-REFERENCE TO RELATED APPLICATIONS

This application claims benefit of U.S. provisional patent application Ser. No. 63/303,237, filed Jan. 26, 2022, which is herein incorporated by reference.

### BACKGROUND

### Field

This disclosure relates to the field of the cleaning of components used in semiconductor processing equipment, wherein a material is deposited or formed on the surface of the component as a byproduct of the process performed in the processing equipment, and when the amount of the deposit is formed on the component can or will adversely affect the processing in the processing equipment, the component is processed to remove the coating deposited thereon as a byproduct of the process performed in the processing equipment.

Components used in certain process environments in process equipment such as process chambers wherein a deposition process or a coating process is performed to coat objects in the process chamber, or an etch or material removal process is performed to etch or remove a coating on an object in the process chamber, often become coated with the deposition material or with by-products of the etching or material removal process. This coating can be created incrementally, for example a coating as thick as or thinner than the coating on the object being coated is formed or deposited on the chamber components exposed to the process environment in the process chamber each time an object is processed to be coated in the processing equipment. Similarly, in etching or material removal processes, by products of the etch or material removal processes may deposit on the walls or other surfaces of the chamber components exposed to the process environment. This coating, when it reaches a certain thickness, can flake off of the component and become a process contaminant, for example by becoming attached to the object being coated or by settling on a support provided to support the object within the object processing chamber or system, which can scratch the surface of the object being coated on the supported side thereof in the processing chamber or system. Because the process chamber component is typically a high cost component of the processing chamber, the component is commonly recycled for reuse one or more times. This recycling of the component requires that the coating formed thereon as a byproduct of the process to which it was exposed be removed and the component cleaned, and the component may then be suitable for reuse. In some cases, the component will have a protective coating thereon prior to being used in the process environment or process chamber, and removing the coating which is a byproduct of the process environment may also remove some or all of the protective coating. In that case, the protective coating will also need to be replaced. Additional undesirable coatings can be a result of natural oxidation of a component or other effects, such as resulting as a byproduct of combustion, for example in an internal combustion engine, gas turbine engine, etc. Again, to refurbish the component, the byproduct coating needs to be removed. During the refurbishment of components exposed to materials which form an undesirable coating thereon as a byproduct of the use of the component, the undesirable coating on the surfaces of the component must necessarily be removed. Removal processes typically include:
a) chemical processes, for example wet etching processes where the component is exposed to a liquid etchant, and the chemical composition of the etchant reacts with the undesirable coating on the component to chemically remove the coating;
b) dry etching techniques such as plasma etching wherein a plasma activated chemical species reacts with the undesirable coating to remove it from the component; and
c) Physical removal processes, such as grit blasting, where the component is bombarded with grit or particulates to physically abrade away the undesirable coating from the underlying surface of the component.

Combinations of these processes or techniques may also be employed in order to remove the undesirable coating from the component.

Many materials, such as certain metals, metal oxides and other material coatings on an underlying component are difficult or considered impractical or impossible to remove using wet or dry etching chemistries and techniques without also damaging the underlying component. For example, hafnium oxides and aluminum oxides, as well as other coatings compositions, are often not readily removable using chemical etching techniques. For example, the time to remove the undesirable coating may be excessive, or the possible chemistries available for wet etching of the coating to remove the coating using known wet etching techniques do not effectively remove the undesirable coating at a sufficiently high removal rate to be commercially feasible for use, or they may adversely also etch the underlying material of the component. Additionally, a component having the undesirable coating removed therefrom may have critical dimensions, for example critical hole sizes, material thicknesses or physical feature dimensions, which are required to remain within a manufacturers' or other specified tolerance to effectively reuse the component in a process chamber. Where the undesirable coating material reacts slowly with the etchant, and the etchant is also reactive with the component material, material will be removed from the component and the critical feature dimension may no longer be present in the component. When this occurs, the component is no longer useable for its intended purpose, and will need to be replaced. Often, the etchant material will have a greater etching or reaction rate with the material of the undesirable coating as compared to the reaction rate with the underlying component. However, the undesirable coating will often have different thicknesses across the surface of the part, and the isotropic nature of wet etching will result in portions of the component surface being exposed to the etchant, while other portions of the components are still covered in the undesirable coating material which is to be removed. As a result, over-etching or removal of a portion of the underlying component can occur.

Some materials are not readily susceptible to removal by wet or dry etching techniques, because the etch rate of the coating is so low that the time to remove the coating is excessive. Here, the coating is frequently removed by bead or grit blasting, where the coating is physically removed by beads or grit impinging upon it and breaking the coating away from the surface of the component. However, the underlying component surface becomes exposed to the bombarding beads or grit and the beads or grit erodes the exposed component surface, removing material therefrom and resulting in dimensional changes which will ultimately require replacement of the component. Where the component is a part used in a process chamber used in the manufacture of semiconductors, the dimensional integrity of the part is often critical to at least one of the electrical, fluid flow, temperature or other process properties, and thus critical to the repeatability of the manufacturing process. Where materials such as hafnium oxide, aluminum oxide, and other hard to remove materials, or etching byproducts thereof, are deposited on these components, bead or grit blasting is considered the only practical way to remove the coating because the reaction rate of the coating with an etchant is so low that the time to etch away the undesirable coating is considered commercially impractical.

### SUMMARY

Provided herein are methods and apparatus for removing coatings layers from the surface of a component, including at least an exterior surface of the component, a recessed surface of the component such as a hole or opening thereinto, an interior surface of the component accessible from the exterior of the component, or other component surfaces having a material adhered thereon or thereto that it is desirable to remove. In one aspect, a coating removal vessel includes an outer body comprising a processing volume and an opening thereinto, a cover over the opening, the cover including a seal therein contactable with a surface of the outer body and the cover, a component holder removably locatable in the processing volume, a heater configured to heat a cleaning fluid, when supplied to the processing volume, to a temperature greater than the boiling point of the cleaning fluid at the ambient pressure surrounding the coating removal vessel, and a pressure regulator, wherein with the component holder located in the processing volume, and the cover is sealingly connected to the vessel to close the opening and seal the processing volume from the surrounding ambient, and a cleaning fluid is locatable in the processing volume is heatable to a temperature above its boing point in the surrounding ambient but self pressurizes to a pressure sufficient to prevent boiling thereof in the pressure vessel.

In another aspect, a method of removing a coating from a component includes providing a coating removal vessel having a sealable processing volume therein, providing a coating removal fluid, which reacts with the coating, at an elevated temperature above the ambient temperature surrounding the removal vessel, in the sealable processing volume, locating a component having a coating thereon to be removed in the coating removal vessel in the processing volume thereof, sealing the sealable process volume from the ambient surrounding the processing volume, heating the coating removal fluid to a temperature greater than the boiling point thereof at the pressure of the surrounding ambient, removing the coating from the component using the coating removal fluid at the temperature greater than the boiling point thereof at the pressure of the surrounding ambient, reducing the temperature of the coating removal fluid to a temperature less than the boiling point thereof at the pressure of the surrounding ambient, venting the sealable volume to the surrounding ambient, and removing the component from the processing volume.

In another aspect, a coating removal system includes a containment vessel having an interior volume and a sealable door and one or more coating removal vessels configured to be received within the containment vessel.

In another aspect, a method of removing a coating from a component includes providing a containment vessel having an interior volume and a sealable door, providing one or more coating removal vessels configured to be received within the containment vessel, providing a coating removal liquid in the coating removal vessel, locating a component into a coating removal vessel, locating the coating removal vessel within the interior volume of the containment vessel, and closing the sealable door to seal the interior volume, and increasing the pressure and temperature of the coating removal fluid to a temperature greater than the boiling point of the coating removal fluid while maintaining the coating removal fluid in a liquid state.

### BRIEF DESCRIPTION OF THE DRAWINGS

FIG. 1 is a schematic sectional view of a coating removal chamber;

FIG. 2 is a schematic illustration of the coating removal chamber of FIG. 1 showing the connections thereof to peripheral equipment useful for the operation thereof;

FIG. 3 is a plan view of the coating removal vessel of FIG. 1; and

FIG. 4 is a schematic view of a component configured to provide its own pressurizable internal volume for the cleaning thereof;

FIG. 5 is a schematic view of an alternative material removal system, wherein individual coating removal chambers or vessels are processed in a containment vessel;

FIG. 6 is a side view of a containment vessel of FIG. 5;

FIG. 7 is a plan view of the pressure vessel of FIG. 5;

FIG. 8 is a schematic view of another alternative coating removal system.

### DETAILED DESCRIPTION

Herein, methods and apparatus are described for removing coatings from underlying components, for example from components used in manufacturing equipment, including components used in semiconductor manufacturing equipment and exposed to a semiconductor processing environment. Herein, a base component, i.e., a component in a condition prior to being placed into a type of processing equipment and exposed to the process environment, has an underlying material composition, which can include a component made up of a single material, a part composed of several different materials, a coated part where the coating is intended to protect the underlying component material from exposure to a manufacturing environment, or other compositions.

Such exemplary parts include silicon carbide components such as rings, etc., and metal components such as shields, chambers, showerheads, exhaust ducts, etc., used in processing equipment. These components have critical thicknesses, critical hole dimensions, and other critical feature dimensions. The dimensions of the holes, including the diameter(s), taper angles, depths, etc. are considered critical to the effective use of the shield in a manufacturing environment, for example in a semiconductor processing chamber. It is well known that during use, film layers form as coatings on the surfaces of these components and must be removed after a certain period of time, deposited thickness, process equipment operating hours, or other criteria. Because the components are expensive, the user of the manufacturing equipment will clean and reuse them, which includes removing the film layer, i.e., the undesirable coating, deposited thereon during use. The number of times the component can be reused is dependent, in part, on how much of the underlying material of the component is removed during the coating removal process, particularly in critical dimension regions such as the holes thereof. The desire of the user of the component is to remove the coating from the component, and reuse the component the greatest possible number of times.

Here, to remove the coating, the coating removal fluid, i.e., a removal fluid having an active chemistry therein capable of etching away, i.e., removing, the undesirable coating at room temperature (20 C) but at an unacceptably low etch rate, or incapable of removing the material of the underlying coating at room temperature, is used at a temperature of the fluid above the boiling point of the fluid at atmospheric pressure. This is accomplished by maintaining the removal fluid with a component disposed therein at a super-atmospheric pressure, i.e., a pressure above local ambient atmospheric pressure where the process is performed, during the exposure of the component to the coating removal fluid. Thus, the material of the undesirable coating deposited thereon during use of the component in a processing chamber or manufacturing environment is contacted with a coating removal fluid that is at a temperature greater than its boiling point at normal or local atmospheric pressure, i.e., at or near 760 torr. Alternatively, the removal fluid may be maintained at a temperature at which maintenance of the coating material fluid in the liquid state becomes difficult because of excessive vaporization thereof, for example at 70% to 100% of the boiling point temperature at atmospheric pressure.

Thus, in one aspect, there is provided a coating removal vessel 100 functioning to receive a component therein at atmospheric pressure, and providing a sealed environment to elevate the temperature of the coating removal fluid therein to a temperature greater than its boiling point at atmospheric pressure while maintaining the conditions therein such that the removal fluid does not boil. This is accomplished by maintaining the coating removal fluid in a sealed environment within the vessel 100, and then heating the fluid from a temperature below its boiling point in the ambient surrounding environment to a temperature above that boiling point. Because the fluid volume is sealed, as the fluid emits vapor as it gets near its atmospheric pressure boiling point, the vapor is sealed within the fixed volume of the vessel. As the vapor has a lower density than the coating removal fluid, it will remain in the headspace above or over the coating removal fluid and will become pressurized as the temperature of the coating removal fluid is increased, resulting in the coating removal fluid's vapor pressure and more vapor is evolved therefrom, becoming equalized with the increased pressure in the headspace, and that pressure is sufficient to prevent the coating removal fluid from boiling, although it is at a temperature above its boiling point at atmospheric pressure. At this higher temperature than achievable in liquid coating removal fluid when the coating removal fluid is exposed to ambient atmospheric conditions, the etch rate of the coating material is significantly increased for the particular coating removal fluid chemistries. This allows for wet etching removal of a coating on a component which was either impossible or impractical using wet etchants in the prior art.

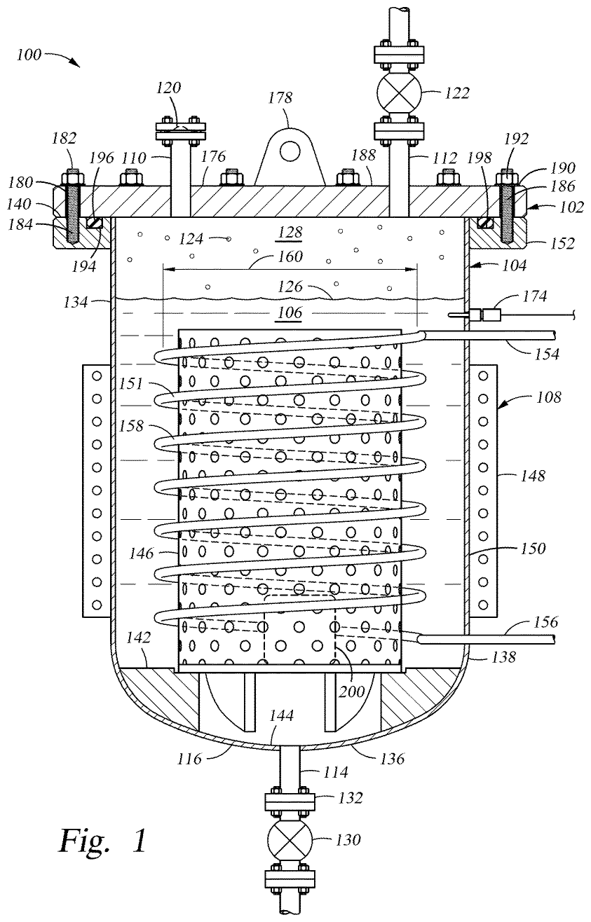

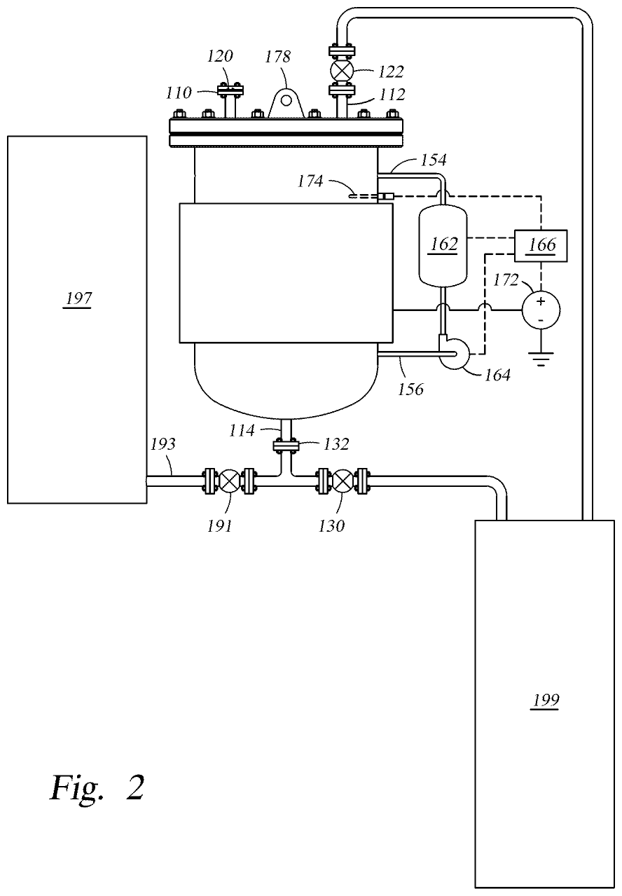

Here, in one aspect, a coating removal vessel 100 is shown in section in FIG. 1 and generally includes a generally right annular body 104 forming a processing volume 106 therein, a removable cover 102, releasably secured to the body 104, a temperature maintenance system 108, a first fluid line 110 in fluid communication with the processing volume 106 through the cover 102, a second fluid line 112 in fluid communication with the processing volume 106 through the cover 102, and a third fluid line 114 inlet, forming a fluid outlet, in fluid communication with the processing volume 106 through the base 116 of the body 104. First fluid line 110 is closed, at the end thereof distal to the cover 102, with a rupture disk 120. The rupture disk 120 is configured to break or rupture at a pressure lower than the pressure at which the coating removal vessel 100 would fail, or would leak, due to an overpressure condition thereof. Alternatively, a pressure relief valve may be used in place of the rupture disk 120. The second fluid line 112 is connected to a collection vessel 199, through a vent valve 122 as shown in FIG. 2. The vent valve 122 may be manually or automatically operated, to allow fluid within the processing volume 106, including super-atmospheric vapor 124 in the headspace 128 of the coating removal vessel 100, generated by heating the removal fluid 126 therein, to be released from the processing volume 106. The third fluid line 114 is here configured to provide a fluid drain to allow the removal fluid in liquid form to be drained by gravity from the processing volume 106 of the coating removal vessel 100. Here, a drain valve 130 is connected to the end of the third fluid line 114 distal to the exterior of the base 116 of the body 104 through a flanged connection 132. The drain valve 130 may have manual or automatic operation, or both, and the drain valve 130 is maintained in a closed condition during operation of the coating removal vessel 100 to remove a coating from a component 200 shown schematically and disposed in the processing volume 106.

Body 104 is configured generally as a right annular housing, having a circumferential vessel wall 134 extending circumferentially about the processing volume 106, a convex base wall 136 extending from the lower circumferential end wall 138 of the vessel wall 134, and a circumferential flange 152 forming the upper end wall 140 of the body 104. A landing surface 142 is provided on the inner surface 144 of the convex base wall 136 facing, and bounding the lower portion of, the processing volume 106. The landing surface 142 can be a circumferential ledge extending inwardly of the processing volume 106 from the inner surface 144 of the convex base wall 136, a series of projections extending inwardly of the processing volume 106 from the inner surface 144 of the convex base wall 136 and spaced from one another in a circumferential path, a separate insert located on the extending inwardly of the processing volume 106 from the inner surface 144 of the convex base wall 136, or another structure. The landing surface 142 desirably extends in a direction perpendicular to the direction of gravity, i.e., generally horizontally and parallel to the upper end wall 140, and is configured to allow a component holder such as a cage or basket 146 to be placed thereon without sliding in a direction toward the vessel wall 134. The basket 146 is used to contain or hold one or more components 200 have a coating or coatings thereon to be removed therefrom in the coating removal vessel 100.

Temperature maintenance system 108 is provided to heat the removal fluid 126 in the processing volume 106 to a desired temperature for removing of the coating or coatings on a component 200 in the processing volume 106, and maintain the desired temperature of the removal fluid 126 during the coating removal process. The temperature of the coating removal fluid 126 fluid can be maintained at a single temperature or within a desired temperature range during removal of the coating from the component 200, or different temperatures or temperature ranges may be used at different times during the coating removal process. To provide this capability with vessel 100, temperature maintenance system 108 includes a heater 148 surrounding the exterior surface 150 of the vessel wall 104, and a cooling channel 151 extending, at its opposed first and second ends 154, 156 through the circumferential flange 152 and therebetween within the processing volume 106 and in contact with the removal fluid 126. Here, the cooling channel 151 is configured as a length of tubing through which a fluid coolant can be flowed, wherein the portion thereof within the processing volume 106 is configured in the shape of a right annular coil 158 having a coil inner diameter 160. The coil inner diameter 160 is configured to be greater than the maximum width dimension of the basket 146, to allow the basket 146 to be freely placed into and removed from the processing volume, and maintain a gap between the sides of the basket 146 and the adjacent surrounding surfaces of the coil 158 to allow removal fluid to be present therebetween. The opposed first and second ends 154, 156 of the cooling channel 151 are fluidly connected to a chiller 162 and a pump 164, shown schematically in FIG. 2, and the chiller 162 and pump 164 are operatively connected to a system controller 166. The chiller 162 cools a fluid coolant flowing from the second end 156 of the cooling channel 151 and the pump 164 causes the chilled or cooled fluid to flow into the first end 154 of the cooling channel 151. The heater 148 is provided as a heating jacket or other heating system that can encircle the exterior surface 150 of the vessel wall 134. The heater 148 can be provided as a single encircling element such as a heating blanket, as multiple encircling elements each smaller in height than the height of the vessel wall 134 and stacked one over the other, as individual heater segments disposed side by side around the exterior surface 150 of the vessel wall 134, or combinations thereof. The heater 148, or individual separate portions thereof when employed, are electric resistance heaters that are operatively connected to a power supply 172, which is operatively connected to the system controller 166 (FIG. 2). A thermocouple 174 is located in the processing volume and is operatively connected by a thermocouple wire to the system controller 166. The system controller 166 monitors the temperature of the removal liquid in the processing volume using the thermocouple 174. Although only one thermocouple 174 is shown, multiple such devices may deployed at different locations within the processing volume 106.

As will be described further herein, the heater 148 is used to heat the coating removal fluid 126 to a desired coating removal temperature thereof, under control of the system controller 166 operatively connected to the power supply 172. The fluid flowing through the cooling channel 151 is used to remove heat from the removal fluid. By operation of the system controller 166 causing cooling and heating of the coating removal fluid during a coating removal process on a component 200 in the processing volume 106, one or more desired set-point temperatures or ranges of temperatures can be reached and maintained during a coating removal process.

Cover 102 is configured to be releasably secured to the circumferential flange 152 forming the upper end wall 140 of the body 104. When removed, the processing volume 106 is accessible to place the basket 146 and component 200(s) therein into the processing volume 106, or remove them from the processing volume 106. The securement of the cover 102 to the circumferential flange 152 is can be provided by clamps, bolts or the like, and here the cover 102 includes, projecting from the cover upper surface 176 thereof, a lifting eye 178 to which a hoist or overhead lifting crane can be connected for lifting of the cover 102 off of the upper end wall 140 of the body 104, and a plurality of fastener openings 180 extending therethrough and spaced from one another along a bolt circle 180. The circumferential flange 152 includes a corresponding in number, to the fastener openings 180, studs 182 exiting generally perpendicular to the upper end wall 140 of the body 104. Each of the studs is arranged along, and spaced from one another along a bolt circle at the same spacing as that of the fastener openings 180. Each stud 182 includes a base portion 184 extending inwardly of the circumferential flange 152 from the upper end wall 140 of the body 104, and a threaded shank portion 186 extending in the direction away from the upper end wall 140 of the body 104 by a distance greater than the thickness of the cover 102 at the location of the fastener openings 180 therethrough.

To releasably secure the cover 102 to the body 104, the cover 102 is lowered onto the upper end wall 140 of the body 104 such that the shank portion 186 of a different stud 182 is aligned to pass into each different fastener opening 180. Thence the cover 102 is further lowered to cause the inner cover surface thereof, adjacent to the perimeter thereof, to come to rest against the upper end wall 140 of the body 104. As a result, a portion of the shank portion 186 of each of the studs 182 extends outwardly of the outer cover surface 188 by a distance sufficient to place a washer 190 and a threaded nut 192 over the protruding portion of each stud 182. By tightening the nuts 192 on the threaded shaft, the inner cover surface is biased against the upper wall surface 140. To prevent leakage of fluid outwardly between the inner cover surface and the upper wall surface 140, a seal groove 194 extends inwardly of the upper end wall 140 at a location inwardly of the bolt circle of the studs 182, and also extends circumferentially around and into the upper end wall 140. A seal ring 196 is positioned in the seal groove 194, such that the seal ring 196 is in contact with the base 198 of the seal groove 194 over its circumferential expanse. The seal ring 196 and seal groove 194 are sized such that the seal ring 196, in its free, uncompressed state, extends outwardly of the seal groove 194 while it contacts the base 198 of the seal groove 194. As the cover 102 is lowered onto the upper end wall 140, the inner cover surface engages this projecting portion of the seal ring 196, and as the cover 102 is further lowered in the direction of the upper end wall 140, the seal ring 196 becomes compressed to maintain contact between the seal ring 196 and the base 198 of the seal groove 194, and maintain contact between the inner cover surface and the seal ring 196. This seals of the interface region between the inner cover surface and the upper end wall 140 to prevent fluid leakage through the interfacing surfaces thereof.

During the use of the removal vessel 100 to remove an unwanted or undesirable coating from a component 200, the component 200, or a plurality thereof, is placed into a basket 146 and the basket 146, with the component 200 therein, is lowered into removal fluid 126 present in the processing volume 106. The cover 102 is then lowered onto the upper end wall 140 and secured to the upper end wall 140 by placing a washer 190 over each projecting portion of each stud 182 and threading a nut 192 onto the projecting portion of each stud 182. The nuts 192 are then tightened to secure each of the washers against the outer cover surface 188 and thus the cover 102 to the body 104.

Once the cover 102 is secured to the body 104, the system controller 166 initiates the power supply 172 to supply power to the heater 148 and initiates the pump 164 to begin pumping a cooling fluid through the cooling channel 151. The cooling fluid may be pumped during, after, or both during and after the heating of the removal fluid 126. When the desired temperature of the removal fluid is reached, the system controller 166 controls the chiller 162 to appropriately cool the cooling fluid which has taken up heat while being flowed through the cooling channel 151, and simultaneously control the operation of the heater 148 by varying the voltage, current, or both supplied to the heater 148 by the power supply 172, to maintain the desired temperature of the removal fluid 126.

When the basket 146 having the component 200 from which the coating is to be removed is placed into the removal fluid 126, and the cover 102 is secured to the upper end wall 140, the removal fluid and any air disposed between the removal fluid 126 and the cover 102 are at or exposed to atmospheric pressure. During the subsequent heating of the removal fluid to the desired process temperature to remove the coating on the component 200, the vent valve 122 and drain valve 130 are maintained in the closed position, and thus fluid is prevented from flowing outwardly of the processing volume 106. As the processing volume 106 is sealed by the vent valve 122 and drain valve 130 positions and by the cover 102 connected to the upper end wall 140, as the removal fluid 126 is heated, vapor 124 will evolve. As the vapor has a lower density than the removal fluid 126 present in a liquid state and surrounding the component 200 to be processed, the vapor 124 will collect in the headspace 128 above the liquid removal fluid 126. As this vapor 124 continues to evolve, the pressure in the headspace 128 increases to a level greater than the surrounding ambient atmospheric pressure. This pressure results in the liquid removal fluid's vapor pressure becoming equalized with the increased pressure in the headspace and thus the coating removal fluid, now at a pressure greater than atmospheric pressure, is at a pressure having a higher boiling point within the processing volume 106 than its boiling point at the ambient atmospheric pressure immediately surrounding the vessel 100. Thus, the removal fluid 126 in liquid form can be heated to a temperature well above its boiling point at the surrounding ambient atmospheric pressure, as the vapor 124 evolved from the liquid removal fluid 126 will rise into the headspace 128 and further increase the pressure within the processing volume 106.

As the removal fluid heats to a desired processing temperature to remove the coating from the component 200, the etching or removal rate of the removal fluid 126 surrounding the component 200 increases. This increase allows the removal fluid to remove coatings which were previously removed using bead or grit blasting or other physical removal techniques. Here, the chemistry of the removal fluid is selected to be relatively unreactive to the material of the component underlying the coating to be removed therefrom, but sufficiently reactive to allow the coating to be removed from the component in a commercially reasonable period of time. The cleaning process is terminated, i.e., endpoint is reached, when the coating is removed from the component, after which the removal fluid is passively or actively cooled, and the headspace 128 is vented to atmospheric pressure through the second fluid line 112 and vent valve 122.

Numerous process endpoint paradigms can be used to determine when to vent the processing volume 106 of the removal vessel 100 through the second fluid line 112 by moving the vent valve 122 to the open position. For example, a coating removal process time, temperature, etch rate and the thickness of the coating to be removed can be considered. The amount of time the part has been exposed to the high temperature removal fluid and the ramp time between the initial removal fluid temperature to the higher process temperature, and from the higher process temperature to the temperature at which significant vapor does not evolve at atmospheric pressure, is selected based on the thickness of the coating layer to be removed. As the removal liquid will still be reactive with the coating as the temperature is rising to the process temperature or falling to the opening temperature of the removal fluid, one must take this into account to determine how fast to ramp the temperature up and down, and how long to maintain the component 200 and the removal fluid surrounding the component 200 in a liquid state at the elevated temperature.

To remove the component 200 from the coating removal vessel 100, the system controller 166 controls the chiller 162 to continue to cool the cooling fluid which has taken up heat while being flowed through the cooling channel 151, and simultaneously control the power supply 172 to stop supplying power to the heater 148. The system controller 166 may increase the flow rate of the coolant through the pump 164, increase the heat removal from the cooling fluid by the chiller 162 to reduce the temperature of the cooling fluid entering the coil 158, or both, to increase heat removal from the removal fluid 126 and decrease the time until the removal fluid 126 is cooled to a temperature sufficient to allow the coating removal vessel to be vented and opened. When the temperature of the removal fluid 126 is below the boiling point thereof at atmospheric pressure, the vent valve 122 may be opened to vent the vapor from the headspace and equalize the pressure on or at the opposed outer cover surface 188 and inner cover surface. The venting can be performed at any time, either before or after the removal fluid 126 temperature has fallen below the boiling point thereof at atmospheric pressure. However, venting when the removal fluid 126 temperature is at or above the boiling point thereof at atmospheric pressure could initiate immediate boiling of the removal fluid unless the vent line is pressurized. Once the headspace 128 pressure is equalized with the surrounding ambient pressure, the nuts 192 are unthreaded from the studs 182, the washers 190 are removed, and the cover 102 is lifted off of the body to allow access to the basket 146. The basket 146 is removed, and replaced with an additional basket having one or more components 200 therein to perform removal of the same coating material on one or more additional components 200.

The removal fluid chemistry may be changed by removing the coating removal fluid 126 by opening the drain valve 130 and allowing the removal fluid 126 to drain from the processing volume 106. Thereafter the inner walls of the body and the cover are flushed with, for example, a buffering agent followed by one or more flushings with deionized water, and the drain valve 130 is moved the closed position. With the cover 102 off the body 104, and the drain valve 130 in the closed position, the new removal chemistry is poured into the processing volume 106. Alternatively, the third fluid conduit 193 may be used to flow the new removal fluid into the processing volume 106. Here, a series of valves and at least one T-connection on the drain line downstream of the third fluid line 114 inlet can be configured to direct used removal liquid to a collection facility such as the collection vessel 199, or to allow fresh or different removal fluid to be flowed inwardly of the third fluid line 114 inlet and into the processing volume 106 from a removal fluid storage 197. For example, as shown in FIG. 2, drain valve 130 may be closed, and refill valve 191 opened, allowing removal fluid 126 in removal fluid storage 197 to pass inwardly of the processing volume 106 through the third fluid line 114. Thereafter, refill valve 191 is closed, and the above described cycle for operation of the vessel 100 to perform coating removal from a component is performed one or more times on one or more components 200.

In another aspect, the component itself can be or provide the pressure vessel for performing coating removal from the interior thereof at high temperatures. Here, for example, a process chamber itself is cleaned, wherein the inner walls of the chamber have been coated during processing of parts therein, and the coating must be removed. Other components, for example gas manifolds and process pipings, through which during use gases are flowed and the gas can form a deposit on the inner surfaces of the manifold or tubing, may also be used in this manner, to form an internal sealed environment for high removal fluid temperature removal of the coating, for example a temperature of at least 50% of the boiling point of the removal fluid at the local ambient atmospheric pressure, as well as above the boiling point of the removal fluid at the local ambient atmospheric pressure. Where the inner volume of a component must have a deposited coating removed therefrom, if the inner volume can be sealed off and safely pressurized to an above ambient surrounding pressure, then the component can be employed to provide the pressure vessel for containing the heated removal fluid heated above its boiling point at atmospheric pressure.

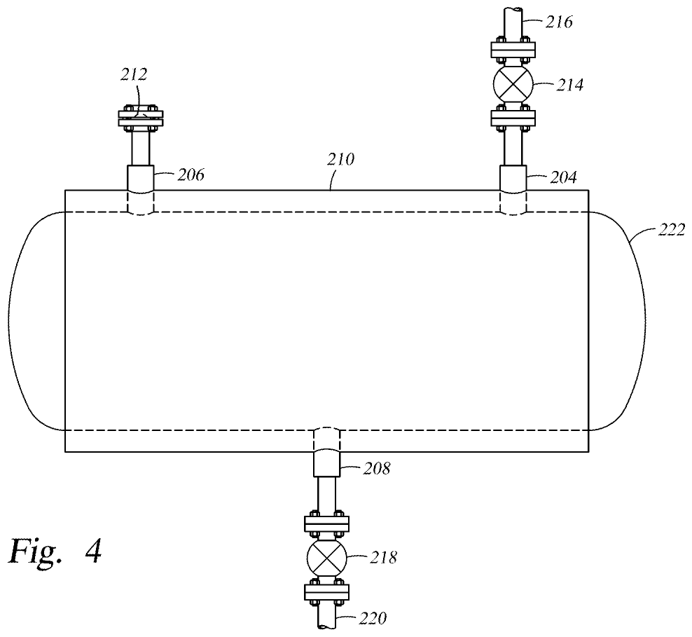

FIG. 4 schematically shows such a component, here a manifold 222, where in use in a processing environment gases enter the interior thereof through sealable threaded connections and leave the interior thereof through sealable threaded connections. Here, manifold 222 includes a hollow body 202, which may include internal baffles, internal tortuous pathways, or other internal architectures (not shown) configured to enable two gas streams to intermix therein. A first manifold inlet 204 and a second manifold inlet 206 comprise fluid conduits in fluid communication with the internal volume of the manifold 222, and a manifold 222 fluid outlet 208 is likewise in fluid communication with the interior volume of the manifold 222. Here, the manifold 222 itself provides the sealed pressure vessel for cleaning the internal surfaces thereof. To enable this, the manifold is wrapped in a component heater 210, which surrounds the outer surfaces thereof, or alternatively placed in an oven to heat the manifold 222, and the coating removal fluid therein, to a temperature above the boiling point of the removal fluid 126 at the surrounding atmospheric pressure.

Similarly to the coating removal vessel 100, here a rupture disk 212 is connected to, and seals off, the second manifold inlet 206, and a relief valve 214 is fluidly connected, in a release fluid circuit 216, to the first manifold inlet 204. Likewise, a manifold drain valve 218 is fluidly connected, within a drain line 220, to the outlet 208.

To perform material removal on the interior surfaces of the manifold 222, or another component having internal surfaces to clean, removal fluid is flowed into the interior thereof through the first manifold inlet 204, or alternatively, through the outlet 208, after which the relief valve 214 is closed and the component heater 210 is powered and generates heat to increase the temperature of the removal fluid. As the manifold drain valve 218 is likewise closed, and the rupture disk 212 seals off the second inlet 206, as the removal fluid is heated and evolves vapor or gas thereof, the vapor or gas is trapped within the inner volume of the manifold, and the pressure within the manifold 222 increases to a temperature where the removal fluid 126 would excessively evaporate or boil at atmospheric pressure. The manifold 222 is held at this elevated temperature for a predetermined period of time to ensure complete removal of the undesired coating on the inner surfaces thereof, and then the power to the heater 210 is removed and the manifold allowed to return to a lower temperature. Then, the relief valve 214 is moved to the open position thereof, and the manifold drain valve 218 is likewise moved to the open position thereof, and the removal fluid is drained to a collection vessel such as that of FIG. 2. The interior of the manifold 222 is then flushed, for removal of residual removal fluid 126 therein, with a buffer solution and then with deionized water to remove any residual removal fluid from the interior thereof.

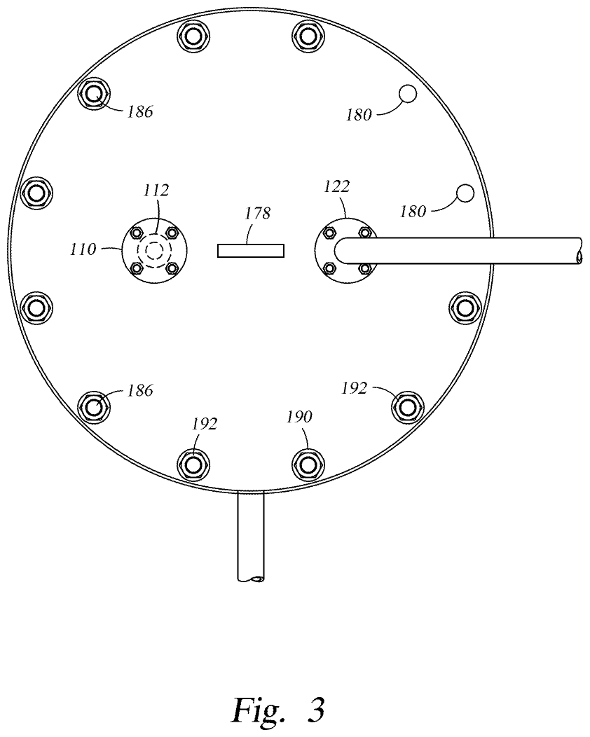

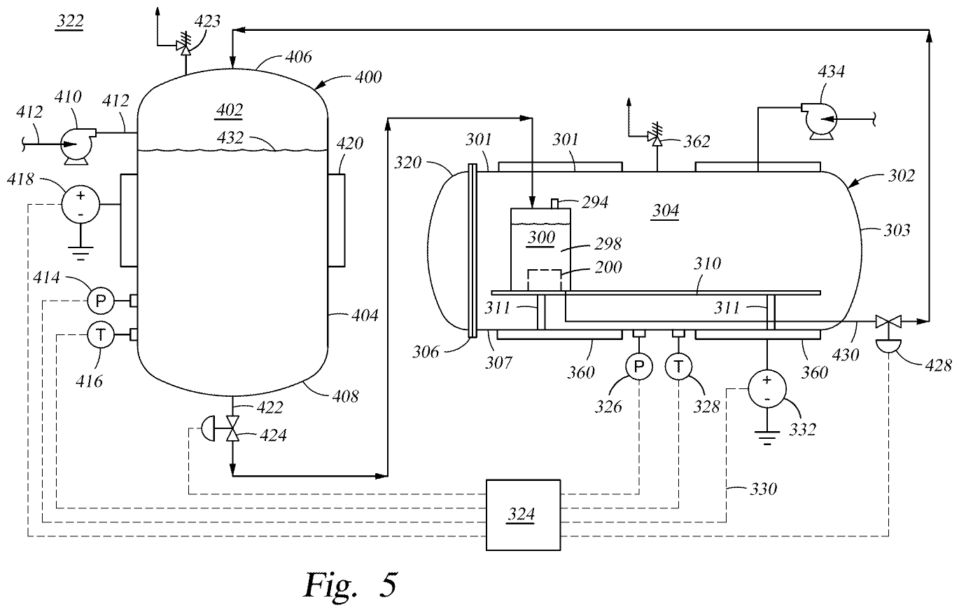

Referring now to FIG. 5, an alternate construct of a coating removal system is shown, in which one or more coating removal vessels 300 are disposable inside of a sealable containment vessel 302, and the containment vessel is pressurized to enable super-atmospheric wet, or liquid, etching of a component in a coating removal vessel 300. Here, in contrast to the removal vessel 100 of FIGS. 1 to 4 hereof, the coating removal vessel 300 need not be independently pressurized with respect to its surrounding ambient, i.e., nor independently heated, with respect to the surrounding internal containment volume 304 of the containment vessel 302, and the coating removal vessel 300 is instead filled with pressurized coating removal fluid while in the containment vessel 302 to allow or enable the pressure within the coating removal vessel 300 located therein to be maintained at above local atmospheric ambient pressure surrounding the containment vessel 302. Here, the containment vessel 302 itself can be heated, such that the fluid therein is maintained at or above the desired temperature of the coating removal fluid in the coating removal chamber 300. In this manner, the coating removal vessel 300 need not be constructed of materials having sufficient strength to withstand a pressure difference between the interior and exterior thereof. Thus, the coating removal vessel can be constructed of materials selected for their resistance to reacting with the removal chemistry used to remove a coating from a part and resistance to reacting with the reaction products of the removal process, and for ease of cleaning the surfaces thereof.

Containment vessel 302 here is a pressure vessel having a generally right annular body shell 301 formed of, for example, stainless steel, having at one end thereof a hemispherical cap 303 welded to one generally annular end wall of the body shell 303, and a door 320 hingedly connected to the opposed end of the body shell 301. Door 320 can be swing open to provide access to the containment volume 304 through a resulting opening 306, and closed and latched to allow the interior containment volume 304 to maintain a pressure above the surrounding ambient pressure. A latch is provided to secure the door 320 closed relative the open end 306 of the containment vessel, and appropriate seal or seals are provided to create a pressure tight seal between the door 320 and the annular wall 307 of the containment vessels surrounding the open end 306. Alternatively, studs, washers and nuts can be used to secure the perimeter of the door 320 to the annular end wall 307 of the body shell 301.

In contrast to the configurations for removing the coating from a part of FIGS. 1 to 4 hereof, here, the part or parts from which a coating is to be removed are placed into one or more coating removal vessels 300 at a location exterior to the containment vessel 302. For example, the coating removal vessels 300 can be located on a wet bench, and the parts from which a coating is to be removed loaded therein on the wet bench. The coating removal vessels 300 may be configured to include a body generally surrounding a processing space and having an opening thereof covered by a cover. Thereafter, the coating removal vessel 300 or vessels 300 are loaded into the open end 306 of the containment vessel 302. A shelf or pedestal 310 is supported off of the lower portion of the body shell 301 by standoffs 311, and the pedestal 310 supports the coating removal vessel or vessels 300 thereon. The interior volume is fluidly connected to a volume of heated and pressurized coating removal fluid in a pressure vessel 400, to selectively fill the coating removal vessel 300 with fluid at the or near the desired processing pressure and processing temperature of the coating removal fluid.

In one aspect hereof, the coating removal vessel(s) 300 are loaded with a component or components from which a coating is to be removed, and placed into the containment vessel without the coating removal fluid located therein. In this aspect, the coating removal fluid is delivered from a separate pressure vessel 400 into the coating removal vessel 300 after it is placed in the containment vessel 302. After placement of the coating removal vessel(s) 300 therein and sealing of the containment volume 304 opening 306 with the door 320, the pressure of the containment vessel 302 is increased to a pressure greater than the ambient pressure surrounding the containment vessel 302. Each coating removal vessel 300 here includes a vent opening 294 extending through the cover thereof, to communicate the pressure within the containment volume 304 with the interior volume of the coating removal vessel, and thereby maintain the pressure of the coating removal fluid to be loaded thereinto to or at the same pressure as that of the containment volume 304.

The pressure in the containment volume 304 can be stepwise increased in one or more steps to a pressure greater than, or equal to, the pressure to be formed or present in the coating removal vessel 300 located therein. In another aspect, the pressure in the coating removal volume 298 of the coating removal vessel 300 can be monitored, and the pressure in the containment volume 304 increased or decreased based on the pressure in the coating removal volume 298, to adjust the pressure of the coating removal fluid in the coating removal volume 298. In the aspect of a material removal system shown in FIGS. 5 to 7, the fluid under pressure within the containment volume is maintained at an elevated temperature to supply heat to the coating material fluid within the coating removal vessel 300. After processing a component to remove a coating from a part or parts in the coating removal vessel 300, as the temperature of the removal liquid is decreased, the pressure in the containment volume 304 can be reduced, but maintained higher or equal to that required to prevent boiling of the coating removal fluid in the coating removal volume 298. Before the door 320 of the containment vessel 302 is opened, the pressure in the containment vessel 302 is brought to the pressure of the ambient surroundings thereof. In this aspect, the coating removal vessel(s) 300 can be loaded with parts and placed into in the containment vessel 302 over multiple parts coating removal processes, i.e., reused, and removed from the containment vessel for the loading and unloading of parts therefrom and thereinto.

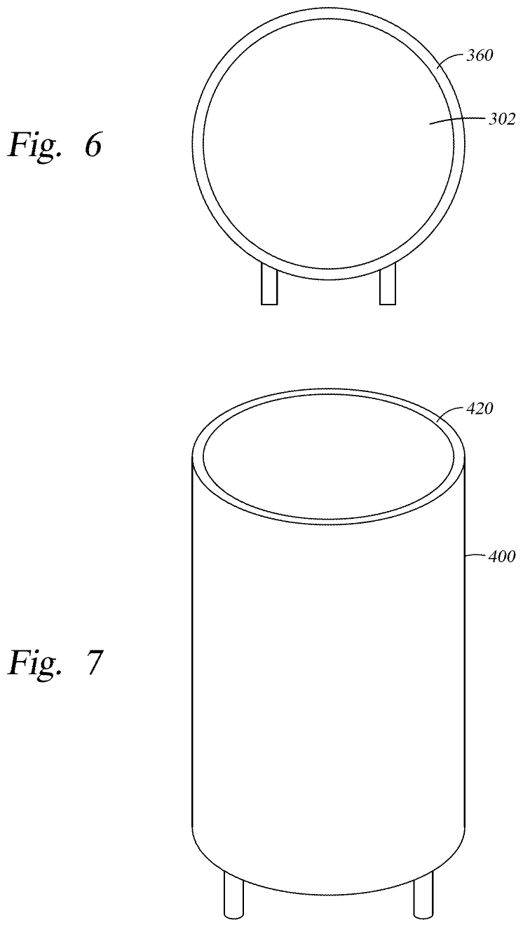

The coating removal system of FIG. 5 generally includes the containment chamber or vessel 302 having the interior containment volume 304, one or more of the removable coating removal vessels 300 replaceably located therein, and utilities connected to at least one of the containment vessel 302 or removable coating removal vessel 300 and configured to control the pressure and temperature of the coating removal process. In FIG. 5, the utilities connect between a system controller 324 and the containment vessel 302, and include one or more containment vessel pressure sensors 326, one or more containment vessel temperature sensors 328, and a containment vessel heater control line 330. The one or more containment vessel pressure sensors 326 and one or more containment vessel temperature sensors 328 are configured to provide an electrical signal indicative of the pressure and temperature within the containment volume 304. However, as noted above, the one or more containment vessel pressure sensors 326 and one or more containment vessel temperature sensors 328 can be connected to directly monitor the pressure and temperature of the interior volume of the coating removal vessel(s) 300. The controller 324 is configured to receive these signals, and send a containment vessel heater control signal to a containment vessel heater power supply 332 which is connected to one or more jacket heaters 360 (FIG. 6) disposed about the exterior surface of the containment vessel. The controller 324 controls the power output of the power supply 332 to the containment vessel heaters 360 based on a desired temperature setpoint for the containment volume 304 or the wall of the containment vessel 302.

Here, to pressurize the containment volume 302, a separate pump 434 or pumps may be provided, and the pump connected to a source of fluid to pump the fluid into the containment vessel 302 to increase the pressure or the containment volume. In another aspect, the containment volume 304 may be maintained at atmospheric pressure. In another aspect, the same pressure vessel 400 used to fill the coating removal chamber(s) 300 with coating removal fluid may be used to supply the coating removal fluid to the containment volume 304 of the containment vessel. In FIG. 5, the pressure vessel 400 supplies the coating removal fluid as a liquid directly to the coating removal vessel(s) 300. The pressure vessel 400 includes an outer circumferential wall 404 and upper and lower hemispherical caps 406, 408, sealingly enclosing a pressurizable volume 402. A pump 410 is provided through a pump line 412 to communicate with the interior pressurizable volume 402 of the pressure vessel. The pump 410 is connected to a fluid supply line 412, to allow pumping of a fluid into the pressurizable volume 402. The fluid supply line 412 is connected to a source of fluid which is to be used as the coating removal fluid supplied to the coating removal chamber(s) 300 for performing the coating removal process. One or more pressure vessel temperature sensors 416 and pressure sensors 414 are provided to supply a signal indicative of the pressure and temperature of the pressurizable volume 402, or of the wall temperature of the pressure vessel 400, to the controller 324. The controller 324 is configured to send a pressure vessel heater power supply signal to a pressure vessel heater power supply 418, which supplies power to one or more jacket heaters 420 on the exterior of the pressure vessel 400.

The pressurizable volume 402 of the pressure vessel 400 is fluidly connected to the interior volume of the coating removal chamber(s) 300 to enable the supply of pressurized fluid thereinto, and the removal of same from the coating removal vessel(s) 300. In FIG. 5, a pressurized fluid fill line 422 extends from the lower portion of the pressurizable volume 402, through a valve 424, through the upper portion of the containment vessel 302 and into the upper interior portion of a coating removal chamber 300. Where multiple ones of the coating removal chamber 300 are processed together in a single containment volume, the fill line 422 is branched to simultaneously fill multiple coating removal vessel(s) 300 with coating removal fluid. A fluid return line 430 extends, through a return valve 428, from the lower portion of the coating removal vessel(s) 300, through the lower wall of the containment volume 304, and thence to the upper portion of the pressurizable volume 420.

In operation of the coating removal system of FIG. 5, with the containment vessel 302 at local ambient pressure 322, in other words at local atmospheric pressure, the door 320 of the containment vessel 302 is opened and coating removal vessels 300 which have been processed in the high pressure, high temperature environment of the containment volume 304 but have been purged or substantially purged of the coating removal fluid are removed from the containment volume 304 through opening 306 after the door 320 has been opened. The parts therein are removed for further processing, and new parts to have a coating removed therefrom are loaded into the same or different ones of the coating removal vessels 300, after which the coating removal vessel(s) 300 are loaded through the opening 306 and placed on the pedestal 310 in the containment vessel 302. The door 320 is then closed and latched to seal and isolate the containment volume 304 of the containment vessel 302 from the surrounding ambient 322.

The pressure vessel 400 is filled or nearly filled with coating removal fluid 432 to be ported or flowed to the containment vessel 302 prior to loading of the coating removal vessels 300 into the containment volume. Here, the pressure vessel 400 can be operated to maintain a desired fluid pressure and temperature of the coating removal fluid 432 therein while parts or components and coating removal vessel 300 are removed and loaded into the containment vessel. For example, the temperature of the coating removal fluid 432 in the pressure vessel 400 can be maintained above the temperature at which it will boil if at atmospheric or surrounding ambient pressure 322, and the pump 410 is used to increase flow coating removal fluid 432 in the liquid state into the pressurizable volume 402 and increase the pressure of that fluid within the pressurizable volume 402 to on the order of greater than one atmosphere to ten or more atmospheres of pressure. Thus, the coating removal fluid can be held at the desired process pressure and temperature thereof for use in removing a coating from a component, for immediate delivery into the coating removal vessel(s) 300 in the containment vessel 302 once the door 320 is closed and the opening sealed. The use of the pressure vessel 400 to maintain the coating removal fluid at the temperature at or near the removal process temperature and flowing that fluid at the or near the coating removal process pressure and temperature into the coating removal vessel(s) 300 reduces the time required to process a part in a coating removal vessel 300, as the need to heat the fluid in situ using a heating blanket or other type heater can be eliminated.

Once the coating removal vessel(s) 300 having the parts or components 200 from which the coating is to be removed are loaded into the containment vessel 302, and the door 320 closed and sealed, valve 424 is opened to allow coating removal fluid 432 to flow from the pressure vessel 432 into the coating removal vessel 300 in the containment volume 304. The higher pressure in the pressurizable volume 402 causes the coating removal fluid 432 to flow into the coating removal vessel 300. Here, the cover of the coating removal vessel 300 includes the vent opening 294, whereby the pressure in the containment volume 304 is communicated into the inner volume of the coating removal vessel 300. Thus, as the pressure in the containment volume 304 is maintained at a pressure slightly below that of the coating removal fluid 432 but a pressure at which the coating removal fluid 432 will not boil at its entry temperature into the coating removal vessel, the coating removal vessel 300 can be filled solely by the difference in pressure between the higher pressure vessel 400 and the lower pressure containment volume 304.

A containment volume relief valve 362 is fluidly coupled to the containment volume 304, such that the pressure in the containment volume 304 can be vented to prevent back pressure therein preventing a sufficient quantity of the pressurizing fluid to cover the components in the coating removal chamber(s) 300. The pump 364 is fluidly coupled to the containment volume 304 to pressurize the containment volume 304, and the relief valve 362 is set to open at a pressure greater than the processing pressure of the parts or components in the coating removal chambers 300. By controlling the pressure in the containment volume 304 using the pump 364 and the relief valve 362, and thus the difference in pressure between the containment volume 304 and that of the coating removal fluid 432 entering the coating removal vessels 300, the flow rate of the coating removal fluid into the coating removal vessel(s) 300 is controlled. The amount of coating removal fluid dispensed to each tank can be controlled or determined by a fluid sensor on an inner side wall of the coating removal vessel(s), a flow meter on the fill line(s) 422, or other methodologies. The pump 410 can be operated during the filling of the coating removal vessel(s) 300, to keep the pressure of the coating removal fluid 432 at or above the pressure required to prevent the boiling thereof as the fluid enters the coating removal vessel 300 and to maintain that pressure above the pressure in the containment volume 304 if the containment volume relief valve 362 opens to vent the containment volume 304. Once the coating removal vessel(s) 300 is filled with the hot coating removal fluid, which is at a temperature greater than that at which it would boil at atmospheric pressure and a pressure sufficient to prevent boiling thereof in the coating removal vessel 304, the fill valve 424 is closed and the coating removal process is performed. The heat of the elevated, to or above process temperature, fluid in the containment volume is transferred through the wall of the coating removal vessel 300 to heat the coating removal fluid therein if required, or vice versa. The containment vessel heater or heaters 460 preferably maintain the fluid in the containment vessel 302 at or above the desired process temperature to reduce heat loss from the coating removal fluid in the coating removal vessels 300. If the pressure in the containment volume 304 falls, the fill pump 434 can be activated to provide additional fluid to the containment volume 304 to maintain the desired processing pressure in the coating removal vessel(s) 300 fluidly coupled thereto. The controller 324 is electrically cabled to the fill valve 424, and the return valve 428, to control the opening and closing thereof with electrical control signals from the controller 324.

The pressure vessel 400 coupled to the coating removal vessel(s) 300 allows the coating removal fluid 432 to be recycled for reuse. Thus, as the process of removing the coating from the parts in the coating removal vessel (s) is nearing its end, the pressure in the pressure vessel 400 is reduced to below that of the containment vessel 302. Once the coating removal process is completed, the return valve 428 is opened by the controller 324, and the higher pressure pressurizing fluid in the coating removal vessels 300 flows into the lower pressure pressurizable volume 402 of the pressure vessel 400. A pressure vessel relief valve 423 is provided to allow the headspace above the returning pressurizing fluid to vent and prevent a back pressure build up preventing refilling of the pressure vessel 400 with the pressurizable fluid 432. The pump 434 can be used to selectively communicate a fluid, such as ambient air, into the containment vessel to maintain sufficient pressure therein to cause the fluid therein to be maintained greater than that in the pressure vessel 400 as the pressurizing fluid is returned to the pressure vessel 400. Simultaneously the power to the containment vessel heaters 360 is removed, allowing the containment vessel to begin cooling to a temperature where it will be safe to open the door 320. Once the pressurizing fluid is returned to the pressure vessel 400, the vent valve 428 is switched to a closed position to isolate the pressurizing volume 402 and the containment volume 304 from one another, and the containment vessel 302 is vented through the containment vessel relief valve 362 or another valve, under operation of the controller 324. Similarly to the aspect of FIGS. 1 to 4 hereof, a cooling coil can be provided to be immersed in the pressurizing fluid in the pressure vessel 400, to more precisely control the temperature thereof. The coil could also be used to cool the wall of the containment vessel 302 after the pressurizing fluid is removed. Other cooling of the containment vessel 302, such as one or more blowers to blow air over the exterior of the containment vessel, can be employed. The coating removal fluid returned to the pressure vessel 400 is heated and pressurized in the pressure vessel, if required, and maintained at that pressure and temperature until the containment vessel 302 is reloaded with new coating removal vessel(s) 300 for processing of components 200 therein to remove a coating therefrom. Although a single pressure vessel 400 is shown connected to a single containment vessel 302, multiple containment vessels 302 can be connected to a single pressure vessel 400. In this case, the pressure vessel 400 can be refilled with coating removal fluid after filling the coating removal vessel(s) 300 in a first containment vessel 302, to heat and pressurize the pressurizing fluid to fill coating removal vessel(s) 300 in another containment vessel. Alternatively, the pressure vessel pressurizing volume 402 can be sized to hold sufficient pressurizing fluid to fill coating removal vessel 300 in two or more containment vessels. Additionally, two or more pressure vessels 400 can be connected to a single containment vessel, to enable one of the pressure vessels to be at process temperature and pressure while the fluid in the coating removal vessel(s) 300 vented to another pressure vessel 400. Additionally, different ones of the pressure vessels 400 can hold different types of coating removal fluid.

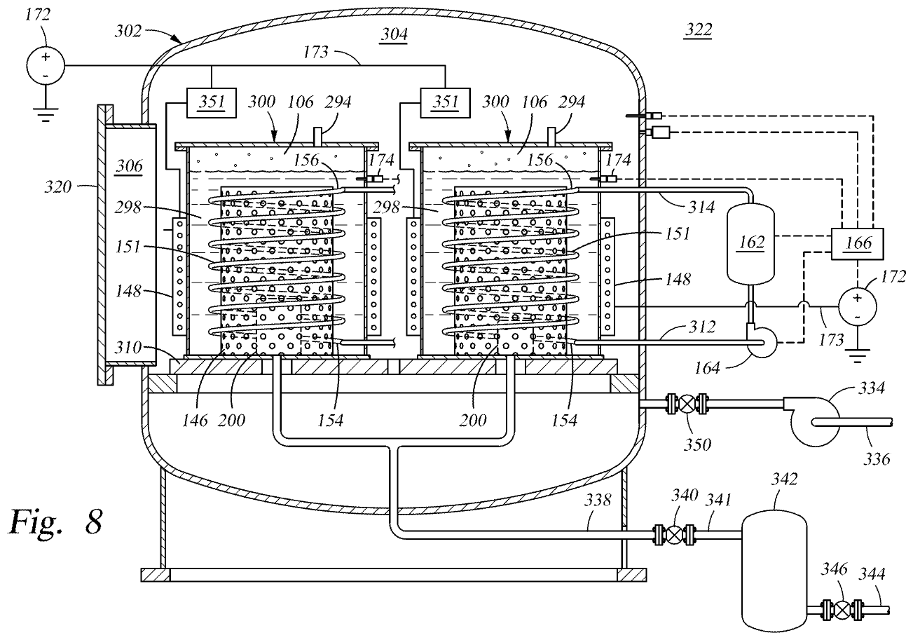

In this aspect of the coating removal system, the coating removal vessels 300 are configured substantially the same as the coating removal vessels 100 of FIGS. 1 to 4 hereof, except they are not pressure tight. In other words, they include the one or more vent openings 294 extending through the wall thereof to allow fluid, or at least fluid pressure, to communicate between the coating removal volume 298 thereof and the surrounding containment volume 304. This allows the pressure within the coating removal vessel 300 to be the same pressure as that in the containment volume 304, so that the materials of the coating removal vessel need not high strength material capable of holding a higher pressure within the coating removal volume 298 than on the exterior of the coating removal vessel 300, thereby allowing the user of the system greater freedom in the selection of the materials used in the coating removal vessel 300. Although the pressurizing of the containment volume is described herein as using air or gas, a liquid such as deionized water, or the coating removal fluid 432, may be used to pressurize the containment volume 304. Referring now to FIG. 8, a further aspect of the coating removal system is shown, as with the coating removal vessel 100, coating removal vessel 300 is configured to be heated, and simultaneously cooled, to maintain a desired temperature of the coating removal volume 298 and any removal fluid therein. Here, lower portion of the coating removal vessel 300 is configured as a fluid reservoir, and a cage, platform, or other holding structure, for example the cage of FIG. 2, is located over the reservoir such that the liquid volume of coating fluid at room temperature (around 20 centigrade) is located below the parts from which a coating is to be removed in the coating removal vessel 300.

Referring to FIG. 8, a modification of the coating removal system of FIGS. 5 to 7 is shown, wherein the containment vessel of FIG. 8 is used, but is shown schematically in FIG. 8, the coating removal vessel(s) of FIGS. 5 to 7 are employed, but here are individually heated, and the pressure vessel 400 is thus not required. Here, the coating removal vessels 300 are held within a containment volume of a containment vessel, but the individual coating removal vessels are individually heated to evolve vapor of the coating removal fluid to pressurize the individual coating removal vessels 300. Similarly to the coating removal vessel 100 of FIGS. 1 to 4, this coating removal vessel 300 includes the temperature maintenance system 108 (FIG. 1) including a heater 148 surrounding the exterior surface 150 of the coating removal vessel wall 104, and a cooling channel 151 extending, at its opposed first and second ends 154, 156 through the circumferential flange 152 and therebetween within the coating removal volume 298 and in contact with the removal fluid 126. Here, the cooling channel 151 is configured as a length of tubing through which a fluid coolant can be flowed, wherein the portion thereof within the processing volume 106 is configured in the shape of a right annular coil. The coil inner diameter is configured to be greater than the maximum width dimension of a basket 146 (FIG. 1), to allow the basket 146 to be freely placed into and removed from the coating removal volume 298, and maintain a gap between the sides of the basket 146 and the adjacent surrounding surfaces of the coil 158 to allow removal fluid to be present therebetween. The opposed first and second ends 154, 156 of the cooling channel 151 are fluidly connected to a chiller 162 and a pump 164, shown schematically in FIG. 5, through fluid quick connections or other type connectors, and the chiller 162 and pump 164 are operatively connected to a system controller 166. Here, a first cooling fluid line 312 extends through the wall of the containment vessel 302 to be connected between the first end 154 of the cooling channel 151 and a cooling fluid pump 164, and a second fluid line 314 extends between the second end 156 of the cooling channel 151 and the chiller 162. The chiller 162 is fluidly connected to the coolant pump 164, such that a continuous fluid loop for pumping to the cooling fluid is created. The chiller 162 cools a fluid coolant flowing from the second end 156 of the cooling channel 151 and the pump causes the chilled or cooled fluid to flow into the first end 154 of the cooling channel 151. The first and second fluid lines 312, 314 may be bifurcated, such that a first portion thereof extends to the wall of the containment vessel and a fluid connector located to allow fluid passage through the wall of the containment vessel, and a second portion thereof leads from the fluid connector to the opposed ends of the cooling channel 151. Here, the second portions can be flexible, and include a second coupling at the cooling channel 151 ends thereof, to be connected to the cooling channel. Flexibility allows for more ease in connection of the first and second fluid lines 312, 314 to the cooling channel.

The heater 148 to heat the coating removal vessel 300, and thus the part(s) and the coating removal fluid therein, is provided as a heating jacket or other heating system that can encircle the exterior surface 150 of the vessel wall 134 of the coating removal vessel 300. The heater can be provided as a single encircling element, as multiple encircling elements each smaller in height than the height of the vessel wall 134 and stacked one over the other, as individual heater segments disposed side by side as vertically extending heater strips around the exterior surface 150 of the vessel wall 134, or combinations thereof. The heaters 148 on each coating removal vessel 300, or individual separate portions thereof when employed, are operatively connected to a power supply 172, which is operatively connected to the system controller 166, through wiring 173. A plurality of wirings, each dedicated to the heater 148 or heaters associated to one coating removal chamber, may be employed, or the wiring 173 may include a master bus cable, from which individual wires or electrical cable extend to the individual heaters 148 associated with each coating removal vessel 300. A variable controller 351 is disposed between each of the coating removal vessels 300 and the power supply 172, to adjust the power supplied to each of the heaters 148. Alternatively, a plurality of power supplies 172, such that a power supply is dedicated to the heater(s) 148 associated with each individual coating removal vessel 300. A thermocouple 174 is located in the coating removal volume 298 of each coating removal vessel 300 and is operatively connected by a thermocouple wire to the system controller 166. The system controller 166 monitors the temperature of the removal liquid in the coating removal volume 298 using the thermocouple 174. Although only one thermocouple is shown, multiple such devices may deployed at different locations within the coating removal volume 298. By varying the power supplied to the heaters 148, and the flow of the cooling fluid to the cooling channel 151 of each coating removal vessel 300, the temperature of the coating removal fluid can be controlled.

The containment vessel 304 is configured as a pressurizable volume capable of maintaining sealing and structural integrity at pressures greater that the pressure surrounding the containment vessel, which surrounding pressure is normally in use local ambient atmospheric pressure. During the operation of the process to remove a coating from a part(s), the containment vessel 302 is positively pumped using a relatively non-reactive gas such as nitrogen or air, or an inert gas such as argon, to increase the pressure therein, i.e., in the containment volume 304 thereof. The containment volume 304 may be maintained at pressures greater than the ambient surrounding pressure of for example 1.1 times the surrounding ambient pressure, greater than 1, to 1.5 times, the ambient surrounding pressure, greater than 1, to 2 times, the ambient surrounding pressure, or greater, for example ten times greater than the surrounding ambient pressure. The containment vessel 302, and the door 320 are configured of stainless steel which provides sufficient strength to withstand the difference in pressure between the containment volume 304 and the surrounding ambient pressure.

The containment volume 302 is connected to the gas source or fluid source, for example a supply of nitrogen or a gas inert or relatively non-reactive with the coating removal fluid, through a gas supply 336 coupled to a pump 334. Pump is configured to pump the gas into the containment volume to achieve a pressure greater than the atmospheric pressure surrounding the containment vessel 302. Pump 334 may be a compressor. A fluid removal line 338 is fluidly coupled to the containment volume to draw fluid from the containment volume 304. Here, the fluid removal line 338 is connected to a valve 340, which may be varied to change the fluid conductance through the valve 340, from which a foreline 341 extends to a recovery vessel 342 configured to trap of condense the coating removal fluid flowing thereinto, which is connected through a valve 346 to a vacuum source 344, which can be a facility vacuum system of a vacuum pump.

In one method of using the coating removal vessel 300, one or more parts having a coating thereon to be removed is located in a coating removal vessel 300. In one aspect, the coating removal vessel 300 is removed from the containment vessel 302 through the opening 306 when the door 320 is open, and the part or parts located therein replaced with parts or components from which a coating is to be removed. The coating removal vessel 300 is then located on the pedestal or platform 310, and connected to the power supply 172, the controller 166, and the first and second fluid supply lines 312, 314 are connected to the first and second ends 154, 156, of the cooling channel 151. The door 320 is then closed to seal the containment volume 304 from the surrounding ambient 322. In another aspect, the coating removal vessel 300 is maintained within the containment volume 304 and the parts or components from which a coating is to be removed are passed through the opening 306 and placed in a coating removal vessel 300 on the platform 310. Thereafter door 320 is closed to seal the containment volume 304 from the surrounding ambient 322. The pump 334 is then operated to increase the pressure in the containment volume 304 by pumping a gas thereinto. The pump 334 may operate to pump the containment volume 304 to a predetermined pressure greater than that of the surrounding ambient 322, or it may be operated to simply maintain the pressure in the containment volume 304 at or greater than the pressure in the coating removal vessel (300). The heater(s 148 are powered to heat the coating removal fluid to the desired temperature greater than the boiling point thereof at atmospheric pressure. As the temperature in the coating removal vessel(s) 300 increases, vapor of the coating removal fluid is evolved. In one aspect, the coating removal vessel 300 includes one or more vent openings 294, so that the pressure of the containment vessel is communicated to within the coating removal vessel 300. In this aspect, the pressure within the containment volume 304 can be maintained above that where significant vapor evolves from the coating removal fluid, or at a pressure below which the coating removal would begin to boil based on the temperature of the coating removal fluid. In another aspect, the vent openings 294 include a pressure relief valve connected thereto, which can be connected to the controller and operated by the controller to open the vent passage when the pressure in the coating removal vessel 300 reaches an undesirable pressure. The pressure in the containment vessel is controlled using the pump 334 and vacuum system 334 if needed, to maintain the containment volume pressure at a level high enough to prevent the coating removal fluid from boiling as it is heated to a higher temperature for the coating removal process. Additionally, once the desired containment volume 304 pressure is achieved, a valve 350 on the fluid inlet to the containment volume 304 from the pump 334 can be closed, and the pump disengaged, while valve 340 is likewise closed. The pump 334 can be reactivated if there is a fall in pressure in the containment volume 334, by activating the pump 334 after opening valve 350.

After the appropriate time has passed to ensure that the coating has been removed from the part, the pump 334, if not already disengaged and isolated from the containment volume, is disengaged and isolated from the containment volume 304 by closing valve 350, and the valve 340 opened to allow the containment vessel to vent to vacuum lime 344, which may be just below the surrounding ambient pressure of the containment vessel 302. Then when the containment volume has regained the pressure of the ambient 322 surrounding the containment vessel 302, the door 320 is opened so that the parts, or the coating removal vessels with the parts therein, can be removed from the containment vessel, and another set of parts returned to the containment volume and within the coating removal vessel(s) to be processed.

Although here the containment vessel 302 is described as being pressurized with a gas, the containment volume can also be pressurized using a liquid.

Table 1 sets forth exemplary chemistries useful to remove exemplary coatings from exemplary underlying materials. The coatings in Table 1 have previously been considered impossible or impractical to remove using chemical removal processes, i.e., wet etch processes. Thus, grit or bead blasting to remove the coatings, and the consequent inherent removal of the material of the underlying component 200, was the only process used to remove these coatings. As a result, the useful life of the underlying component 200 was limited by the coating removal process as critical dimensions of these component 200s would be brought out of the manufacturers specification thereof after one or more coating removal processes.

TABLE 1

| Underlying | | | | |
|---|---|---|---|---|
| material of the | | | | |
| component | | | | |
| from which the | | | | Process |
| coating to be | | Removal | Removal | time |
| removed is | Coating to be | fluid | fluid | to remove |
| formed | removed | chemistry | temperature | the coating |
| Titanium | Aluminum | KOH/H₂O | 150-300 C. | 1-48 hours |
| | oxide | | | |
| Titanium | Hafnium oxide | KOH/H₂O | 150-300 C. | 1-48 hours |
| Titanium | Aluminum | NaOH/H₂O | 150-300 C. | 1-48 hours |
| | oxide | | | |
| Titanium | Hafnium oxide | NaOH/H₂O | 150-300 C. | 1-48 hours |
| Titanium | Aluminum | NaOH/H₂O | 150-300 C. | 1-48 hours |
| | oxide | | | |
| Silicon carbide | Aluminum | NaOH/H₂O | 150-300 C. | 1-48 hours |
| | oxide | | | |
| Silicon carbide | Hafnium oxide | NaOH/H₂O | 150-300 C. | 1-48 hours |
| Silicon carbide | Aluminum | KOH/H₂O | 150-300 C. | 1-48 hours |
| | oxide | | | |
| Silicon carbide | Hafnium oxide | KOH/H₂O | 150-300 C. | 1-48 hours |

In each case set forth in Table 1, the processing temperature at which removal of the coating is performed is above the boiling point of the removal fluid at atmospheric pressure. For example, a NaOH/H₂O solution at 10% NaOH and 90% H₂O has a boiling point of 105° C., and a solution of 50% NaOH and 50% H₂O has a boiling point of 140° C. A KOH/H₂O solution has a boiling point of in the range of 140 to 150° C. In each case of Table 1, the process temperature is above the boiling point, at atmospheric pressure, of the removal chemistry used to remove the coating. Additionally, the KOH and NaOH removal chemistries are known to be relatively non-reactive with Silicon carbide and Titanium, the material of the underlying components in Table 1. Additionally, at the temperature range at which the KOH and NaOH solutions described in Table 1 can be used in tanks where the solution is exposed to atmospheric pressure, the coating removal rate is so low that it is not commercially viable to remove these coatings using wet etch techniques. Thus, here, in each coating removal step, it is believed that less than 0.1% to 0.5% of the underlying material of the component is removed. As a result, in contrast to coating removal using bead or grit blasting for components having these underlying material compositions, the number of coating removals and reuse of the component is substantially increased.

What is claimed is:

1. A coating removal vessel comprising:
an outer body comprising a processing volume and an opening thereinto;
a cover open the opening, the cover including a seal therein contactable with a surface of the outer body and the cover;
a component holder removably locatable in the processing volume;
a heater configured to heat a cleaning fluid, when supplied to the processing volume, to a temperature greater than the boiling point of the cleaning fluid at the ambient pressure surrounding the coating removal vessel; and
a pressure regulator, wherein
with the component holder located in the processing volume, and the cover sealingly connected to the vessel to close the opening and seal the processing volume from the surrounding ambient, a cleaning fluid locatable in the processing volume is heatable to a temperature above its boing point in the surrounding ambient but self-pressurizes to a pressure sufficient to prevent boiling thereof in the pressure vessel.

2. The coating removal vessel of claim 1, further comprising a headspace in the processing volume located adjacent the cover.

3. The coating removal vessel of claim 1, further comprising a first fluid line disposed on the cover and in fluid communication with the processing volume and a second fluid line disposed on the cover and in fluid communication with the processing volume.

4. The coating removal vessel of claim 1, further comprising a cooling element disposed within the processing volume of the body.

5. The coating removal vessel of claim 4, wherein the cooling element comprises a fluid channel having a first end disposed exteriorly of the body, a second end disposed exteriorly of the body, and an intermediate portion disposed within the body in the processing volume of the coating removal vessel.

6. The coating removal vessel of claim 1, wherein the outer body comprises an outer wall and a heater is disposed about the outer wall of the body.

7. The coating removal vessel of claim 1, further comprising a cooling element disposed within the processing volume of the body and the outer body comprises an outer wall and a heater is disposed about the outer wall of the body.

8. The coating removal vessel of claim 7, further comprising a power supply connected to the heater.

9. The coating removal vessel of claim 8, further including a system controller operatively coupled to the power supply and to the cooling element and configured to control the heat generated by the heater and the heat removed from the processing volume by the cooling element to maintain a desired processing temperature in the processing volume that is greater that the boiling point at the local surrounding ambient pressure of a coating removal fluid disposed in the processing volume.

10. A method of removing a coating from a component, comprising:
providing a coating removal vessel having a sealable processing volume therein;
providing a coating removal fluid, which reacts with the coating, at an elevated temperature above the ambient temperature surrounding the removal vessel, in the sealable processing volume;
locating a component having a coating thereon to be removed in the coating removal vessel in the processing volume thereof;
sealing the sealable processing volume from the ambient surrounding the processing volume;
heating the coating removal fluid to a temperature greater than the boiling point thereof at the pressure of the surrounding ambient;
removing the coating from the component using the coating removal fluid at the temperature greater than the boiling point thereof at the pressure of the surrounding ambient;
reducing the temperature of the coating removal fluid to a temperature less than the boiling point thereof at the pressure of the surrounding ambient;
venting the sealable volume to the surrounding ambient; and
removing the component from the processing volume.

11. The method of claim 10, further comprising, removing the coating from the component in the coating removal vessel, while removing less than 0.05% of the material of the component with the removal fluid.

12. The method of claim 11, further comprising removing the removal fluid that has been exposed to a coating to be removed from a component from the processing volume and providing fresh removal fluid to the processing volume.

13. The method of claim 10, wherein the coating to be removed is one of hafnium oxide or aluminum oxide, and the component material is silicon carbide or titanium.

14. A method of removing a coating of at least one of hafnium oxide or aluminum oxide from an underlying material comprising at least one of silicon carbide or titanium, comprising;
exposing the coating to a removal fluid reactive with the coating but non-reactive with the underlying material on which the coating resides at a temperature where the removal fluid is a liquid at atmospheric conditions at or near 14.7 psi pressure;
maintaining the temperature of the removal fluid at a temperature greater than the temperature where the removal fluid is a liquid at atmospheric conditions at or near 14.7 psi pressure;
removing the coating by reacting the coating with the removal fluid; and then
reducing the temperature of the removal fluid to at, or less than, a temperature where the removal fluid is a liquid at atmospheric conditions at or near 14.7 psi pressure.

15. The method of claim 14, wherein the coating comprises one of hafnium oxide or aluminum oxide.

16. The method of claim 14, wherein the removal fluid does not etch the underlying material of the component.

17. The method of claim 14, wherein the coating comprises at least one of hafnium oxide or aluminum oxide, and the component material comprises at least one of silicon nitride or titanium.

18. The method of claim 17, wherein the removal fluid comprises at least one of KOH or NaOH.

19. A coating removal system, comprising:
a containment vessel having an interior volume and a sealable door; and
one or more coating removal vessels configured to be received within the containment vessel.

20. The coating removal system of claim 19, further comprising a pressure vessel selectively fluidly connected to the interior volume of a coating removal vessel within the interior volume of the containment vessel.

21. The coating removal system of claim 20, further comprising a pump fluidly connected to the pressure vessel.

22. The coating removal system of claim 21, further comprising a heater in contact with the outer surface of the coating removal vessel.

23. The coating removal system of claim 22, further comprising a heater in contact with the outer surface of the containment vessel.

24. A method of removing a coating from a component, comprising:
providing a containment vessel having an interior volume and a sealable door;
providing one or more coating removal vessels configured to be received within the containment vessel;
providing a coating removal liquid in the coating removal vessel;
locating a component into a coating removal vessel;
locating the coating removal vessel within the interior volume of the containment vessel, and closing the sealable door to seal the interior volume;
increasing the pressure and temperature of the coating removal fluid to a temperature greater than the boiling point of the coating removal fluid while maintaining the coating removal fluid in a liquid state.

25. The coating removal method of claim 24, further comprising providing a pressure source selectively fluidly connected to the interior volume of the containment vessel; and
flowing a pressurizing fluid from the pressure vessel into the containment vessel.
